(19) United States
(12) Patent Application Publication
(10) Pub. No.: US 2012/0136744 A1
(43) Pub. Date: May 31, 2012

(54) ESTABLISHING CONSUMER DRIVEN BUYING GROUPS SOLICITING SUPPLIERS USING ONLINE RESERVE AUCTIONS

(76) Inventor: Jonathan Lem, Elk Grove, CA (US)

(21) Appl. No.: 13/302,850

(22) Filed: Nov. 22, 2011

(51) Int. Cl. G06Q 30/08

(52) U.S. Cl. 705/26.3

(57) ABSTRACT

A method of conducting a consumer driven online mass purchase of goods or services or both goods and services via reverse auction. At least one consumer posts an online announcement of the intended purchase and enlists other consumers using email lists, social networks, and other lines of communications. Deposits may be collected from participants. A predetermined number of participants may be established. A date may be established for responses by potential commercial providers of the offerings. At the established date, responses in the form of bids of a reverse auction are considered. The combined orders of the participants are awarded to the low bidder.

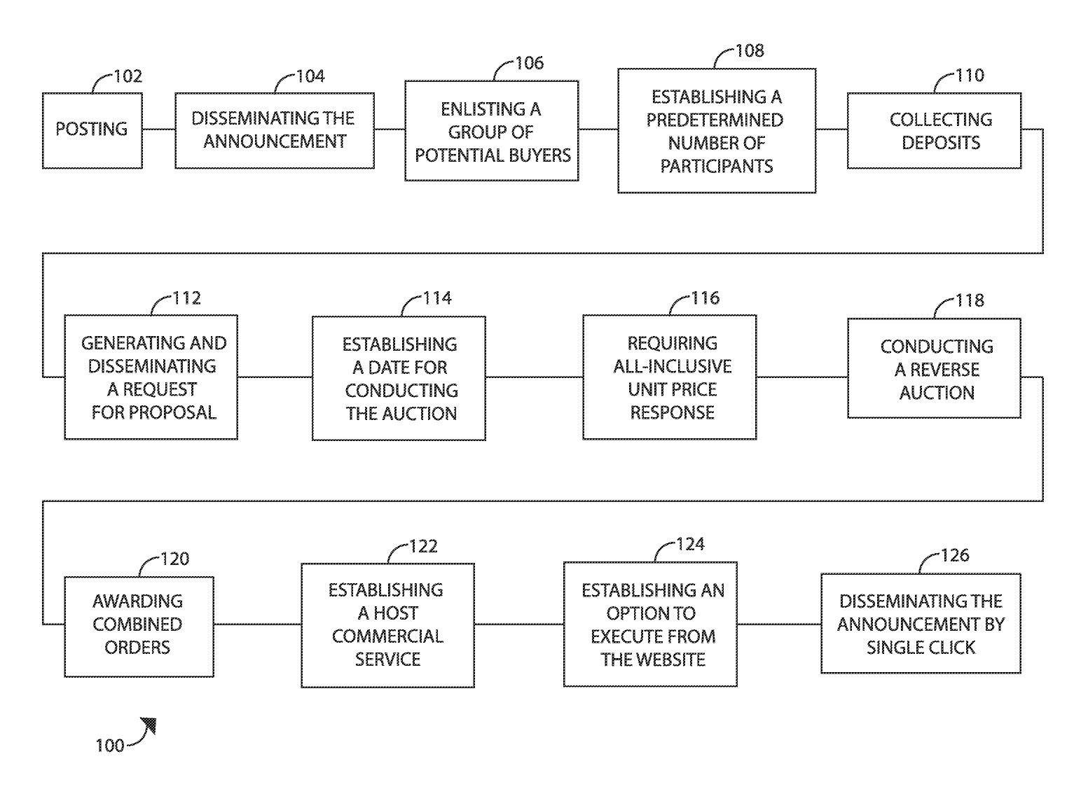

### FIELD OF THE INVENTION

The present invention relates to online commerce, and more particularly to a method enabling large numbers of consumers to unite and conduct online reverse auctions in which suppliers of goods or services or both respond to a request for proposal to furnish specified goods or services or both.

### BACKGROUND OF THE INVENTION

The advent of the internet has facilitated commerce by enabling widespread communications between buyers and sellers. Part of the benefit comes from the reach of the internet. Yet even beyond this lies the ability of large numbers of people to unite across time and space and to act as a single entity typically known as buyers' groups.

A buyers' group may establish a temporary market, or single opportunity for vendors to provide their goods or services responsive to a single or one-time solicitation. This solicitation may result in what has been called a reverse auction in which vendors compete by submitting proposed prices intended to be lower than those of the competing vendors. The overall concepts of reverse auctions and buyers' groups are known. However, because online commerce is still in its infancy, there remain as yet unrecognized and unsolved problems facing online commerce generally and online reverse auctions more specifically.

### SUMMARY OF THE INVENTION

The present invention furthers online reverse auctions by incorporating certain features previously unrecognized or underdeveloped. For example, to promote assurance that a reverse auction conducted by a buyers' group will actually reach fruition, deposits may be demanded from each member of the buyers' group. In another example, to promote assurance that vendors will respond to solicitations to participate in reverse auctions, a minimum number of buyers may be established so as to fully exploit the power of mass production and mass sales. In a further example, reverse auctions incorporating these improvements may be made available from a commercial host which establishes a website enabling potential buyers' groups to form and conduct reverse auctions while enjoying the convenience of a pre-established host platform. One optional feature of the commercially host website is establishment of a single-click procedure to accomplish dissemination of the announcement of the intended purchase in one step, while reaching at least one and preferably a plurality of public venues such as social networks.

It is an object of the invention to improve reverse auctions in online commerce by promoting assurance of completion of purchases conducted by reverse auctions.

Another object of the invention is promote convenience of reverse auctions in online commerce by making participation as easy and convenient as possible for individual buyers, and to encourage consumer driven purchasing initiatives to be conducted.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawing, which is a block diagram showing steps of the method of the present invention.

### DETAILED DESCRIPTION

The present invention is an improved method of conducting a consumer driven online mass purchase of offerings of goods or services or both goods and services via reverse auction wherein sales rights are granted to the lowest supply bidder. The novel method enables consumers to initiate reverse auctions as opposed to having retailers, distributors, and manufacturers initiate the reverse auction.

As summarized in the Drawing FIGURE, the novel method 100 may comprise a step 102 of posting an online announcement announcing that a buyers' group is forming. This enables large numbers of consumers who may or may not know one another to join together. Advantages of this grouping include greater likelihood that a responding potential supplier will deem it worth his while to participate, and that the large number of sales will assure the lowest price to the buyers.

In a step 104, details of the announcement are disseminated through outside channels other than the original online announcement. For example, the announcement may be posted on a number of general social networks such as Facebook® and Twitter®, and social networks having restricted scope, such as Linked In®. Publicity is not restricted to online social networks. The announcement may be sent by email, instant messaging, and in other ways.

The result of dissemination of the announcement is a step 106 of enlisting a group of potential buyers responsive to posting of the online announcement.

In order to interest potential suppliers of the goods or services being solicited, a step 108 of establishing a predetermined number of participants from potential buyers may be practiced. The predetermined number is typically a minimum, the magnitude of the predetermined number being sufficiently great as to result in the advantages for potential suppliers and the buyers set forth above.

A step 110 of collecting deposits from participating potential buyers may be practiced in order to assure seriousness of potential buyers indicating interest. This also acts as a reassurance to potential suppliers that the sale will proceed and not be abandoned.

Once the predetermined number of participants is achieved and once deposits are collected, should these options be implemented, a step 112 of generating and disseminating a request for proposal specifying conditions of sale of the offerings to potential suppliers is conducted. The proposal requires acceptance of conditions and a bid responsive to the conditions. In some cases, where potential suppliers are known to the buyers' group that has been formed, solicitations may be sent directly to these suppliers. Alternatively, a general public posting may be made in the hopes that appropriate suppliers will respond.

A step 114 of posting an online announcement comprises the further step of establishing and announcing as part of the online announcement a date in the future for conducting the reverse auction may be practiced as an option.

As another option, a step 116 may be practiced of requiring that supplier respondents couch responses in terms of an all-inclusive unit price for the offering, wherein the all-inclusive unit price includes ancillary charges which must be added to the basic charge for the offering, such that the all-inclusive unit price is the final price which will be paid by each participant of the buyers' group.

The request for proposal initiates a step 118 of conducting a reverse auction by supplier respondents in which that potential supplier respondent which offers the lowest bid is declared the winning bidder.

The step 120 of awarding the combined orders for the offerings from all of the members of the buyers' group to the supplier respondent which is the winning bidder follows at the conclusion of the reverse auction.

In a preferred implementation of the invention, a host operates as a commercial service which offers a software platform providing convenience to consumers who wish to come together but who may lack technical ability to easily implement a reverse auction according to the method 100. The method 100 may therefore comprise an optional step 122 of establishing a host as a commercial service which makes available to the public a website from which the method of conducting a consumer driven online mass purchase of offerings may be implemented, wherein members of the public may implement the method for a fee. The fee may be collected in any mutually satisfactory way, such as being a predetermined percentage of the entire sale, being a fixed fee, or in other ways.

As is regarded as the most practical way of implementing the step 122, the method 100 may comprise a step 124 of establishing an option which is executable from the website and operable to disseminate the online announcement for posting on at least one selected social network website. That is, an appropriate screen may be provided as part of the host website which requires merely filling in of spaces by the buyers, either individually or collectively, to enter information necessary to set forth conditions and initiate the reverse auction. In a further embodiment, after a purchasing announcement has been created, disseminated, and/or viewed, an icon may be created that will allow the prospective consumer to perform a single “click” on the predetermined icon to join the buyers' group. The single click of the icon will join the prospective consumer to the buyers' group in a manner similar to what is known in the art with a Facebook “Like” icon or “Google+” icon.

In a particularly convenient procedure, the method 100 may comprise a step 126 of disseminating the online announcement by a procedure requiring only a single click on one predetermined icon. Dissemination may encompass a plurality of destinations such as social networks, chat rooms, or any venues selected by the buyers' group which may be accessed by communications networks.

Thus a relatively large reverse auction based purchasing transaction may be expeditiously initiated and implemented by large numbers of consumers who do not necessarily know one another.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. A method of conducting a consumer driven online mass purchase of offerings of goods or services or both goods and services via reverse auction wherein sales rights are granted to the lowest supply bidder, comprising the steps of:
posting an online announcement announcing that a buyers' group is forming;
disseminating details of the announcement through outside channels other than the original online announcement;
enlisting a group of potential buyers responsive to posting of the online announcement and disseminating details of the announcement through the outside channels;
establishing a predetermined number of participants from potential buyers;
generating and disseminating a request for proposal specifying conditions of sale of the offerings to potential suppliers;
conducting a reverse auction by supplier respondents in which that potential supplier respondent which offers the lowest bid is declared the winning bidder;
awarding the combined orders for the offerings from all of the members of the buyers' group to the supplier respondent which is the winning bidder.

2. The method of claim 1, wherein the step of posting an online announcement comprises the further step of establishing and announcing as part of the online announcement a date in the future for conducting the reverse auction.

3. The method of claim 1, comprising the further step of requiring that supplier respondents couch responses in terms of an all-inclusive unit price for the offering, wherein the all-inclusive unit price includes ancillary charges which must be added to the basic charge for the offering, such that the all-inclusive unit price is the final price which will be paid by each participant of the buyers' group.

4. The method of claim 1, comprising the further step of establishing a host as a commercial service which makes available to the public a website from which the method of conducting a consumer driven online mass purchase of offerings may be implemented, wherein members of the public may implement the method for a fee.

5. The method of claim 4, comprising the further step of establishing an option which is executable from the website and operable to disseminate the online announcement for posting on at least one selected social network website.

6. The method of claim 5, wherein the option comprises a step of disseminating the online announcement by a procedure requiring only a single click on one predetermined icon.

7. The method of claim 1, comprising the further step of establishing a predetermined icon requiring only a single click to allow a potential buyer to join said buyers' group.

8. A method of conducting a consumer driven online mass purchase of offerings of goods or services or both goods and services via reverse auction wherein sales rights are granted to the lowest supply bidder, comprising the steps of:
posting an online announcement announcing that a buyers' group is forming;
disseminating details of the announcement through outside channels other than the original online announcement;
enlisting a group of potential buyers responsive to posting of the online announcement and disseminating details of the announcement through the outside channels;
collecting deposits from participating potential buyers;
generating and disseminating a request for proposal specifying conditions of sale of the offerings to potential suppliers;
conducting a reverse auction by potential suppliers in which that potential supplier which offers the lowest bid is declared the winning bidder;
awarding the combined orders for the offerings from all of the members of the buyers' group to the winning bidder.

9. The method of claim 8, wherein the step of posting an online announcement comprises the further step of establishing and announcing as part of the online announcement a date in the future for conducting the reverse auction.

10. The method of claim 8, comprising the further step of requiring that supplier respondents couch responses in terms of an all-inclusive unit price for the offering, wherein the all-inclusive unit price includes ancillary charges which must be added to the basic charge for the offering, such that the all-inclusive unit price is the final price which will be paid by each participant of the buyers' group.

11. The method of claim 8, comprising the further step of establishing a host as a commercial service which makes available to the public a website from which the method of conducting a consumer driven online mass purchase of offerings may be implemented, wherein members of the public may implement the method for a fee.

12. The method of claim 11, comprising the further step of establishing an option which is executable from the website and operable to disseminate the online announcement for posting on at least one selected social network website.

13. The method of claim 12, wherein the option comprises a step of disseminating the online announcement by a procedure requiring only a single click on one predetermined icon.

14. The method of claim 8, comprising the further step of establishing a predetermined icon requiring only a single click to allow a potential buyer to join said buyers' group.
